(19) United States
(12) Patent Application Publication
(10) Pub. No.: US 2004/0114392 A1
(43) Pub. Date: Jun. 17, 2004

(54) Effective LED vehicle lamp

(76) Inventor: Wen-Jui Hou, Yungkang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/316,747

(22) Filed: Dec. 12, 2002

(51) Int. Cl. F21V 21/00

(52) U.S. Cl. 362/545; 362/543; 362/544; 362/541

(57) ABSTRACT

A vehicle lamp comprising a casing seat, a substrate with a plurality of LEDs; a reflecting panel and a lampshade. One surface of the reflecting panel is formed with a plurality of receiving chambers; and each receiving chamber is capable of receiving an LED. Light from the LEDs is collected effectively and then emitted out. An inner edge of each receiving chamber of the reflecting panel is a smoother surface or a textured surface. Moreover, the reflecting panel is integral formed with a casing seat for being assembled to a vehicle.

### FIELD OF THE INVENTION

The present invention relates to vehicle lamps, and particular to a vehicle lamp for effectively collecting light and then emitting the light with a larger illumination.

### BACKGROUND OF THE INVENTION

Generally, cars are installed front lights, back lights, and indicators for illumination, especially in a dark light area so that drivers have a safety driving environment. Usually, the backside lights are covered by lampshades, which light up as the driver brakes the car. The function of the front lights are mainly used for providing a better illumination.

In general, the power consumption of the backside lights has a specification of 12 V and 18/5W. This induces a larger power consumption rate. Moreover, a longer time is necessary for lighting up the back lights since heat must warm up the tungsten silks of the back lights. However, this is disadvantageous when the driver brakes the car since other drivers know the condition after a time period and they can not substantially react with the action of the backside lights. Moreover, if the braking actions are performed repeated in driving, the lights are charged and discharged repeatedly. As a result, the lifetime of the backside light will be shortened.

Recently, LEDs have been developed with a preferred performance and thus are widely used in many fields. A plurality of LEDs are arranged on a substrate and then lights from LEDs is refracted by a light collecting surface at an inner edge of a lampshade so as to emit to a radiating area.

However, at this design, since the light are refracted by a light collecting surface at an inner edge of a lampshade so as to emit to a radiating area, the collecting light is too weak to have a better illumination.

### SUMMARY OF THE INVENTION

Accordingly, the primary object of the present invention is to provide a vehicle lamp comprising a casing seat, a substrate with a plurality of LEDs thereon, a reflecting panel and a lampshade. One surface of the reflecting panel is formed with a plurality of receiving chambers; each receiving chamber is capable of receiving an LED. Light from said LEDs is collected effectively and then emitted out.

Another object of the present invention is to provide a vehicle lamp wherein an inner edge of each receiving chamber of the reflecting panel is a smoother surface or a textured surface.

Another object of the present invention is to provide a vehicle lamp, wherein the reflecting panel is integral formed with a casing seat for being assembled to a vehicle.

The various objects and advantages of the present invention will be more readily understood from the following detailed description when read in conjunction with the appended drawing.

### BRIEF DESCRIPTION OF THE DRAWINGS

The present invention will better understood by reference to the accompanying drawings, wherein

FIG. 1 is an exploded perspective view of the present invention.

FIG. 2 is an assembled cross section view of the present invention.

FIG. 3 is an assembled cross section view of the present invention.

FIG. 4 is a lateral cross section view showing another embodiment of the present invention.

FIG. 5 is a lateral cross section view showing a further embodiment of the present invention.

FIG. 6 is a lateral cross section view showing a yet embodiment of the present invention.

### BRIEF DESCRIPTION OF THE DRAWINGS

A vehicle lamp comprises a casing seat, a substrate with a plurality of LEDs thereon; a reflecting panel and a lampshade. One surface of the reflecting panel is formed with a plurality of receiving chambers; each receiving chamber is capable of receiving an LED. Light from said LEDs is collected effectively and then emitted out. An inner edge of each receiving chamber of the reflecting panel is a smoother surface or a textured surface. Moreover, the reflecting panel is integral formed with a casing seat for being assembled to a vehicle.

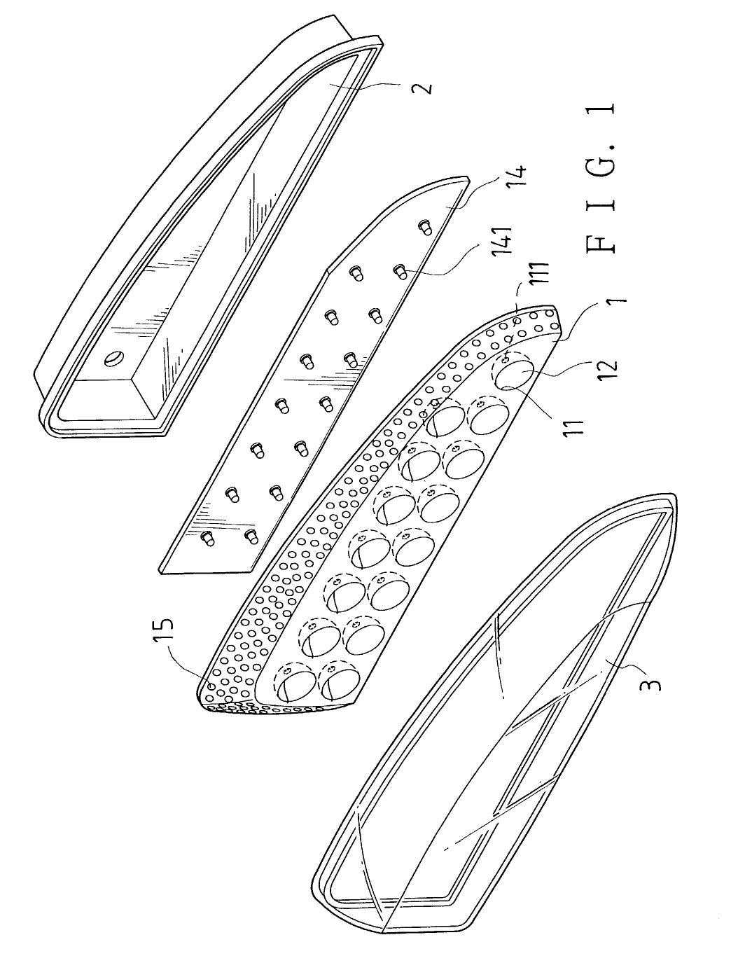

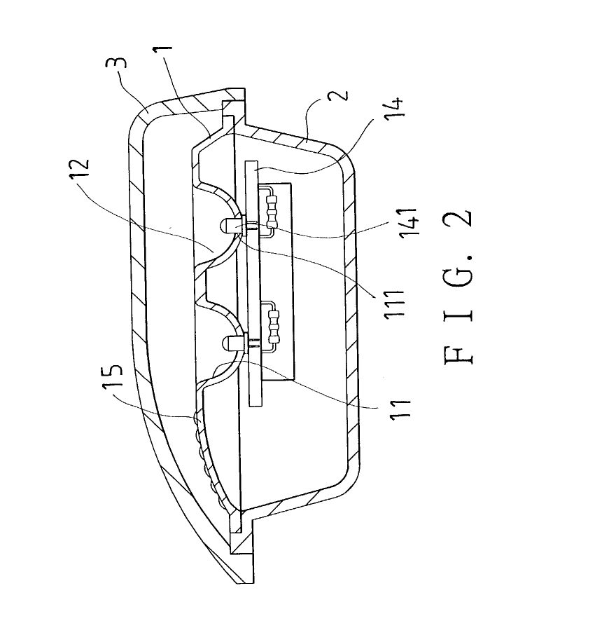

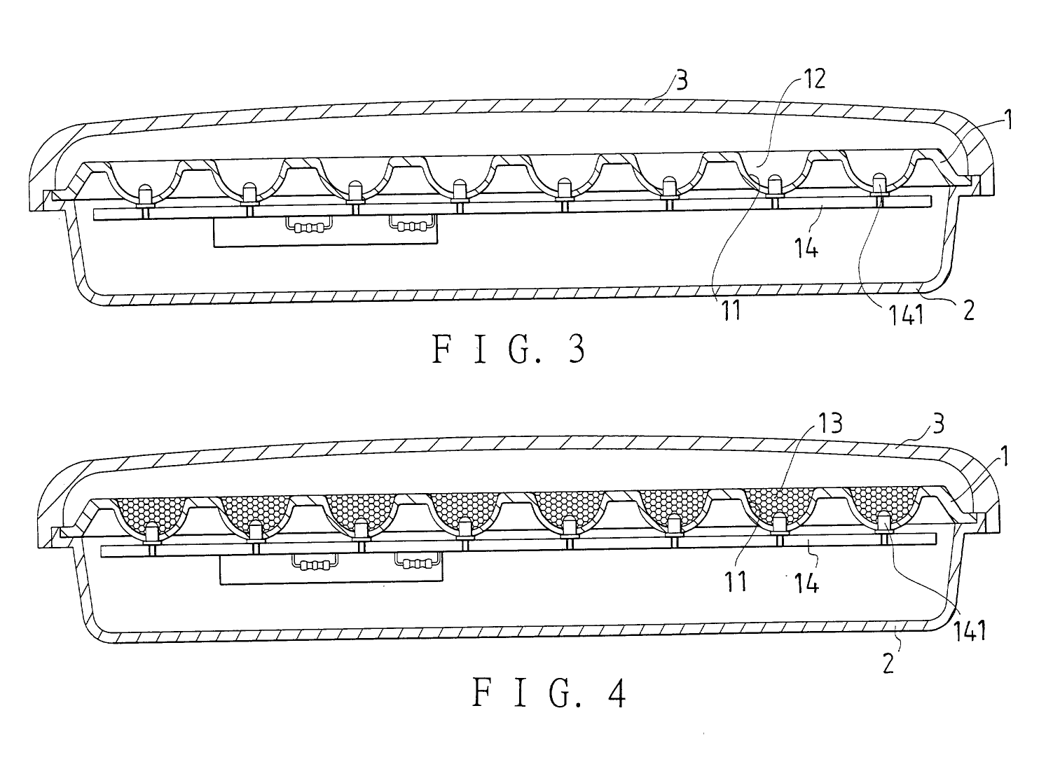

Referring to FIGS. 1 and 2, the vehicle lamp of the present invention includes a reflecting panel 1. A plurality of receiving chambers 11 are concavely formed on the reflecting panel 1. The inner side of the receiving chamber 11 is a smooth cambered optical reacting plane 12 (referring to FIG. 3), or is a textured optical reacting plane 13 (referring to FIG. 4). Each receiving chamber 11 is formed with a receiving hole 111 for receiving an LED 141 on a substrate 14. The LED 141 may be a single color LED or a multiple-color LED. The outer edge of the reflecting panel 1 is extended with round convex or strip-like reflecting portion 15. The reflecting panel 1 and the substrate 14 are assembled to the casing seat 2. An outer edge of the casing seat 2 is covered by a lampshade 3.

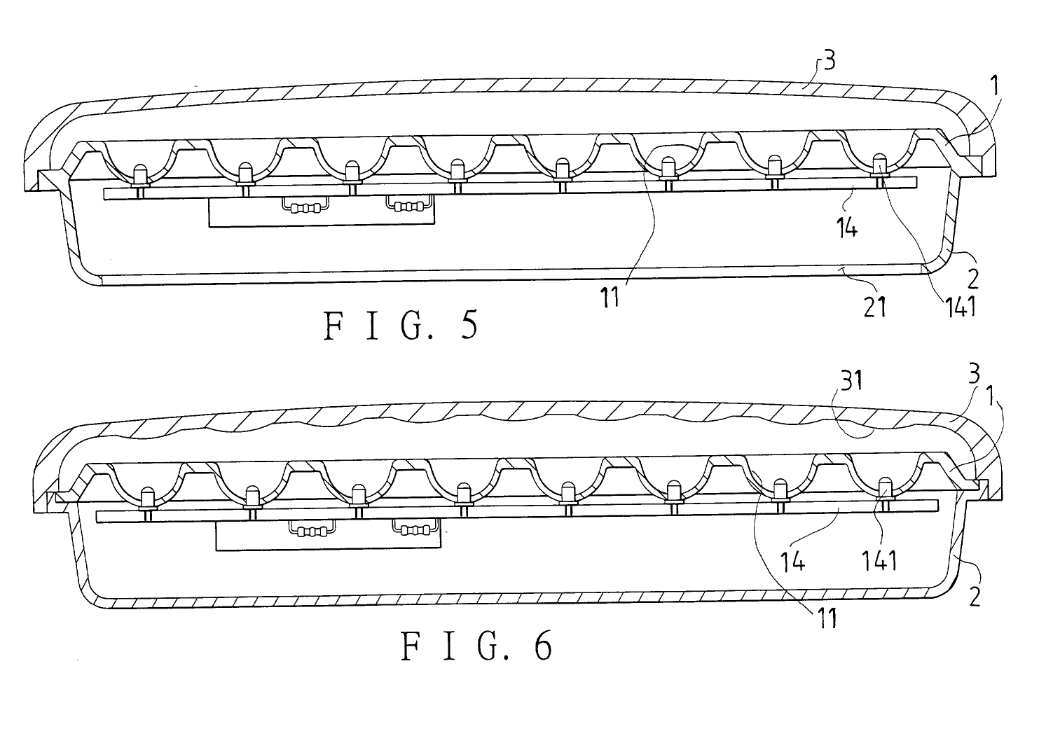

Moreover Referring to FIG. 5, the reflecting panel 1 is integrally formed with the casing seat 2. A rear lateral side of each casing seat 2 is formed with a via hole 21 for assembling the substrate 14 and the casing seat 2 to the reflecting panel 1. Furthermore, with reference to FIG. 6, an interior of the lampshade 3 at an outer edge of the reflecting panel 1 can be formed with a plurality of cambered light collecting surfaces 31.

Thereby, in use of the present invention, the light from the LEDs 141 in the receiving chambers 11 of the reflecting panel 1 is be collected by the smooth cambered optical reacting plane 12, or the textured optical reacting plane 13 and then are emitted out through the smooth lampshade 3 directly which may be collected further by the cambered light collecting surface 31 and then are emitted. Moreover, by the reflecting portion 15 at the outer edge of the reflecting panel 1, light from cars behind the car having the reflecting panel 1 can be reflected to the driver so that the driver may know that the car has near the driver's car.

What is claimed is:

1. A vehicle lamp comprising a casing seat, a substrate with a plurality of LEDs; a reflecting panel and a lampshade, characterized in that:
one surface of the reflecting panel is formed with a plurality of receiving chambers; each receiving chamber is capable of receiving an LED;
wherein light from said LEDs are be collected effectively and then emitted out.

2. The vehicle lamp as claimed as 1, wherein an inner edge of each receiving chamber of the reflecting panel is a smoother surface.

3. The vehicle lamp as claimed as 1, wherein an inner edge of each receiving chamber of the reflecting panel is a textured surface.

4. The vehicle lamp as claimed as 1, wherein the reflecting panel is integrally formed with a casing seat for being assembled to a vehicle.

5. The vehicle lamp as claimed as 1, wherein the reflecting panel is assembled within a casing seat.

6. The vehicle lamp as claimed as 1, wherein the lampshade has a smooth surface and is transparent.

7. The vehicle lamp as claimed as 1, wherein the lampshade is transparent and interior thereof is formed with a plurality of noses for collecting light.

8. The vehicle lamp as claimed as 1, wherein an outer edge of the reflecting panel extends with a reflecting portion for reflecting light from other vehicles.

9. The vehicle lamp as claimed as 8, wherein the reflecting portion of the reflecting panel has a round convex shape.

10. The vehicle lamp as claimed as 8, wherein the reflecting portion has a strip like shape.
